(19) United States
(12) Patent Application Publication
(10) Pub. No.: US 2005/0204001 A1
(43) Pub. Date: Sep. 15, 2005

(54) Method and devices for prioritizing electronic messages

(76) Inventors: Tzvi Stein, Givataim (IL); Jacob Itay, Rishon LeZion (IL); Bernard Juster, Netanya (IL); Guy Peleg, Tel Aviv (IL)

Correspondence Address: BROWDY AND NEIMARK, P.L.L.C.;624 NINTH STREET, NW, SUITE 300, WASHINGTON, DC, 20001-5303, US

(21) Appl. No.: 10/517,346

(22) PCT Filed: Sep. 24, 2003
(86) PCT No.: PCT/IL03/00760

§ 371 Date: Dec. 9, 2004

Related U.S. Application Data
(60) Provisional application No. 60/414,254, filed on Sep. 30, 2002.

(51) Int. Cl. G06F 15/173; G06F 15/16

(52) U.S. Cl. 709/206; 709/224

(57) ABSTRACT

Importance classes are assigned to electronic messages, by identifying the sender and recipient of an electronic message, determining a relative organizational distance between the sender and the recipient, and assigning the electronic message an importance class, according to the relative organizational distance between the sender and the recipient. The importance setting is further weighted by content criteria and a plurality of rules formed by a machine learning algorithm.

### FIELD OF THE INVENTION

The present invention relates to a system and a method for reducing unproductive electronic messages traffic. More specifically, the invention relates to a system and a method to improve the efficiency of electronic messages usage.

### BACKGROUND OF THE INVENTION

Electronic mail (e-mail) is an indispensable tool for both internal and external communication in most organizations. Unfortunately, the unrestricted use of electronic mail, without rules or limitations, has caused e-mail traffic load to explode to the point where it is becoming a real threat to the infrastructure and to the workforce productivity of many organizations.

Many employees receive literally tens or even hundreds of e-mails daily, a great deal of which are unimportant or irrelevant, forcing them to spend a major part of their workday reviewing e-mails, and leaving them short and shorter of time for other, more important tasks. Moreover, too often important messages get buried in the e-mail barrage, and as a result, the reader fails to respond or act upon them.

Many techniques have been proposed for filtering and categorizing e-mail messages. Some of them are simple rule based methods that take simple actions such as automatic response, relying on parameters such as the sender's identity and a basic key word search (as described, for example, in U.S. Pat. No. 5,555,346). Others recommend more complex automatic actions, such as scheduling an appointment (as described in U.S. Pat. No. 6,553,358) or redirecting the message to an alternative communication device (e.g. U.S. Pat. No. 6,499,021). Many prior art systems perform an analysis of the message text, using machine-learning algorithms, and assign it to one of a predetermined set of categories. Some prior art techniques take assistance from additional data such as the sender's identity being a member of the family, or a work associate etc.

A drawback of known techniques is their poor ability to predict the importance of received emails to the recipient and what is the right order to process the massive amount of messages in the user's inbox. Moreover, for employees in medium and large organizations, the vast majority of incoming messages originate from within the organization, and the importance of those is very difficult to based solely on their content. For example, a device failure in a telecommunications service provider's installation discovered by a field engineer, is reported by email to a long distribution list coring of development personnel, customer support personnel, regional sales people and management. The original e-mail message triggers a long chain of messages that may include questions, answers, comments and personal opinions relating to the original message. These messages reach a broad distribution list using the famous “reply all” feature. Many recipients gradually lose interest in the disc but thy keep being copied nevertheless. The e-mails in the chain are very hard to distinguish by analyzing their content since they all include the original problem description, and they all include relevant technical terms. On the other bad, their subjective importance and relevance for different recipients may vary significantly.

U.S. 2002/0071546A1 (Brennan) published Jun. 13, 2002 and entitled “Method device and software for processing incoming communications” discloses methods, devices and software for processing incoming communications such as e-mails whereby incoming messages and calls may be prioritized in accordance with the rank of the message or call originator within the organization. This may be effected by querying an organization chart for the organization on upon receipt of an incoming communication, in order to assess the rank of the originator. The organization chart may be stored in a directory server, and queried by a computing device receiving the message or processing the call.

In all embodiments, higher priority is given when the originator is of higher rank than the recipient. In one variation, the determining metric is the total distance within the organizational hierarchy between a supervisor who is common to the originator and recipient. This variation also accords higher priority to a message whose originator is superior in rank than the recipient.

WO0180535A1 published Oct. 25, 2001 and entitled “Communications Prioritizer” discloses a method of prioritizing a received information message in which the circumstantial origin of the message is indicted by a personalized identifier accompanying or derived from the message in to e-mail or other communications system. The method includes the elements of receiving the message, determining the personalized identifier, looking-up and cross-referencing the personalized identifier to a database of known personalized identifier and priority codes, assigning a priority code to the message per the result of the element of looking-up and cross-referencing, and prioritizing (including categorizing sorting, redirecting, erasing or otherwise acting upon) the received message according to the priority code.

This publication too is based on the rank of the sending party, and does not take into account the rank of the recipient.

### SUMMARY OF THE INVENTION

It is an objective of the invention to provide a method and system that allow incoming messages to be presorted or pre-tagged based on their relative importance as defined by predefined criteria, so as to allow the recipient to attend first to those received messages that are likely to be most urgent.

The present invention addresses this objective by providing a method and system for assigning importance classes to electronic messages. The term “electronic messages” relates to e-mail messages, facsimile messages, or to text data of converted voice messages or pager messages. In the context of the present invention, the term “importance class” relates to the degree of relevance to a certain recipient of a communication, assigned by a system using the method to each of a group, consisting at least one element of electronic messages. The term “assigning importance classes” relates to associating each of a group, consisting at least one element, of electronic messages, with an importance class attribute for example, by means of embedding, tagging or any other acceptable linking method.

The method comprises identifying the sender of an electronic message, identifying the recipient of the electronic message, determining a relative organization distance between the sender and the recipient, and assigning the electronic message an importance class as a function that assigns the importance class regardless of whether the sender and the recipient is of higher rank.

In the context of the present invention, the term “relative organizational distance” relates to a metric derived from an organization hierarchical structure. Specifically, in a preferred embodiment the relative organizational distance is a function of the level of work affiliation between the corresponding departments of the message sender and the message recipient, and of the relative hierarchical level of said sender and receiver. In a further embodiment, this function is refined according to one or more of the following: (a) a set of global control rules according to the organizational structure and the work affiliation among different departments and different hierarchical layers in the corporation; (b) a set of control rules according to ad hoc work groups formed from time to time; (c) a global list of preferred originating addresses, external to the organization, from senders affiliated with the organization.

For example, a message from at individual in the same department as the recipient is often attributed a higher importance than a message arriving from a different department, or a message from the same position level or from a direct supervisor or from a person directly reporting to the recipient, is attributed a hither importance class than a message from a sender positioned much higher or further down in the hierarchy. A message from an essential unit for daily operation (e.g. a message from a research unit to a development unit) is attributed a higher importance than a message from non-essential unit (e.g. legal or administrative). The organizational rules may also be for a specific period of time, for example, a project involving two development teams A and B collaborating for a specific period of time conveys higher importance on communication between the two.

In a further embodiment, the computation of the importance class attribute is a weighted average of the relative organizational distance, and at least one additional criterion, selected from the following: (a) a globally defined content criterion; (b) a personally defined message sender criterion; (c) a personally defined content criterion; (d) a plurality of rules formed by a machine-learning algorithm or algorithms; (e) an analysis of e-mail message headers.

The term “globally defined content criterion” relates to a pre-defined set of key words, terms and phrases, constituting references of “important” and “unimportant” content items found in the text of the message body and/or the message subject field. As the word “globally” indicates, this references set applies for all users' messages. Similarly, the term “personally defined content criterion” relates to such references set of “important” and “unimportant” content items defined individually by a user, which applies only for messages arriving to that users inbox.

The term “machine-learning algorithmus” relates generally to computational models and techniques for automatic improvement of performance, based on past experience. In the context of the present invention, such algorithms are used for tracing users' actions upon receipt of a message, for example, opening, replying, forwarding or deleting. Crossing said actions with other data related to the respective message, for example, sender's identity, content items, etc. and comparing it with past information gathered, allows derivation of new classification rules accordingly, based on the assumption that a user's behavior consistently observed through time indicates of the importance ascribed by the recipient to received messages.

The term “analysis of email message headers” relates to detection, interpretation and processing of a feature or features in message headers, specifically, message headers such as “to”, “cc” and “bcc” fields. An example for such a feature or features is the number of the recipients in the “to”, “cc” or “bcc” field. A user appearance as the sole recipient of a message may imply higher importance or relevance of said message to the recipient.

The present invention further relates to a method for streamlining the management of electronic messages, the method comprising: (a) assigning an importance class to each of said messages; and (b) streamlining said messages in a pre-determined manner in accordance with the respective importance class of each message.

In a preferred embodiment, the streamlining includes displaying notifications of incoming messages either in a color that is characteristic of the respective importance class of each message, or with a distinctive tag that is characteristic of the respective importance class: of each message, or sorted in a pre-determined order, for example, in descending order, indicating their relative importance in respect with their assigned importance classes. In a further embodiment, the streamlining includes blocking messages whose importance class is beneath a predetermined threshold, either with or without alerting the sender that a message has been blocked.

It is to be appreciated that the invention uses the importance level parameter to enable multiple, different operations, for example, the user is able to differentiate the most important messages and focus his/her attention to those messages exclusively; Further examples are the transmission of the most important messages only to the e-mail client (referred to herewith as “selective synchronization”), or the archiving of less important ones (referred to herewith as “selective archiving”), thus the overall e-mail processing efficiency is increased.

In the scope of the present invention is also a system for assigning importance classes to electronic messages, said system comprising:
(a) a message data extraction unit for identifying a sender and a recipient of an electronic message. The message data extraction unit is a series of computer instructions adapted to capture an identification of a message sender and the message recipient; and
(b) a classifier coupled to the message data extraction unit and being responsive to a relative organizational distance between the sender and the recipient for assigning to the electronic message an importance class in inverse dependence on the relative organizational distance between the sender and the recipient. The classifier is a module of compute program capable of associating identities of message senders and message recipients with pre-determined organizational data, for determining the relative organizational distance between respective senders and recipients. The classifier is further capable of calculating an importance class attribute of a message, according to a relative organizational distance between the ender and the recipient.

In a further embodiment, the classifier is further adapted to assigning said importance class based on at least one additional criterion, selected from the following:
(a) a pre-defined message sender criterion;
(b) a pre-defined content criterion;
(c) a plurality of rules formed by a machine-learning algorithm tracing user actions;
(d) an analysis of e-mail message headers.

According to a preferred embodiment, the calculation of the importance class attribute by the classifier further involves a rules formation unit comprising:

(a) a set of global control rules relating to an organizational structure and work affiliation among different departments and different hierarchical layers thereof;

(b) a set of control rules relating to ad hoc world groups formed from time to time in said organizational structure; and

(c) a global list of preferred originating addresses external to the organizational structure.

The set of rules in the rules formation unit may be either pre-determined (i.e. an immutable data object supplied by the system provider) or a dynamic product of the system (i.e. an adaptive, configurable, rule generating module, responsive to user behavior, user configuration, administrator configuration, message content and features analysis, or other system variables).

In a further embodiment the rules schema encapsulated in the rules formation unit includes three categories, as will be explained in detail hereinafter: (a) organizational rules, (b) content dependent rules, and (c) user-behavior based rules.

Organizational rules make use of the infrastructure of the organization to determine the importance of the message, as will be further explained and illustrated in detail hereinafter.

In one embodiment, the system stores the departmental and hierarchical structure of the organization in a database, along with a definition of the work affiliation level between the various departments. The organizational structure information can be input to the system's database using available industry tools, or through a Graphical User Interface (GUI) specific to a system according to the invention.

Alternatively, the system may use a “skeleton” hierarchical structure which is based on permanent relationship between units.

The system enables to define ad hoc groups of users who, for a specific period of time, may require frequent and high priority communication level regardless of their regular position in the organization.

In addition to the organizational data, referred to as “global organizational data”, which is set by the organization, each user is allowed to define individual preferences, referred to as “personal organizational data”. A person, although not bound by the organization, may increase, for his/her own reasons, the importance of messages received from a specific unit.

The content rules in the second rules category determine the importance level attribute according to the degree of correlation between the message's content and reference sets of “important” and “unimportant” content items.

Most reference content items are global, although the system allows each user a limited ability to define personal reference content items, as, long as they do not conflict with the global definition.

The third rules category employs a machine-learning algorithm that updates and refines the said predefined organizational and content rules according to the actions taken by each user on previously received messages. The user's actions are recorded by a “user-behavior agent”. Those actions may be interpreted as indicative of the subjective importance assigned to the message.

Each rule category's contribution to the classification process may vary, depending on weighting factors and on the confidence of each category's decision, which can be either pre-determined or dynamically assigned, for example, the weighting coefficient of the content category could be increased or decreased automatically according to the corresponding confidence in assigning the importance class. In accordance with a preferred embodiment, the organizational category (both global and personal) has the highest contribution, i.e. in the range of 60% to 70% of the total contribution sum. The behavior and content categories contribute the rest.

### BRIEF DESCRIPTION OF THE DRAWINGS

In order to understand the invention and to see how it may be carried out in practice, some preferred embodiments will now be described, by way of non-limiting example only, with reference to the accompanying drawings, in which:

FIG. 1 is a diagram illustrating one embodiment of a system for classifying incoming messages;

FIG. 2 is a diagram illustrating in detail a classification system as featured in FIG. 1;

FIG. 3 is a diagram illustrating the integration of a system as depicted in detail in FIGS. 1 and 2 in an overall environment adapted to the streaming of electronic communication management;

FIG. 4 illustrates in detail the e-mail server interface depicted in FIG. 3;

FIG. 5 illustrates in detail the configuration management and monitoring module depicted in FIG. 3;

FIG. 6 illustrates in detail the e-mail client interface depicted in FIG. 3;

FIG. 7 illustrates in detail the user functions module depicted in FIG. 3;

FIG. 8 is a diagram illustrating the integration of the environment depicted in FIG. 3 in an enterprise network; and

FIG. 9 depicts an example of the flow of execution from a message arrival to a user's inbox until the notification thereof is presented to the user with the appropriate importance class indication.

### DETAILED DESCRIPTION OF THE INVENTION

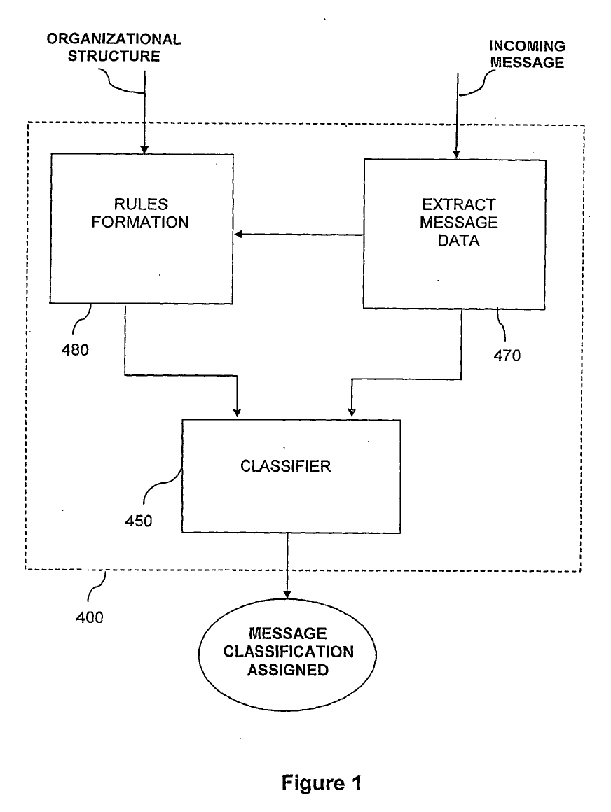

FIG. 1 illustrates a system (400) according to the invention, also referred to herewith as “classification engine”, for classifying incoming messages. The classification engine (400) includes an extract message data unit (470) for gleaning the information required to establishment of the message's importance class, by means of applying, within the classifier (450), a set of classification rules found in the rules formation unit (480). The rules formation unit (480) is able to maintain a repository of pre-determined classification rules, as well as generating new ones, based upon the information obtained from the extract message data unit (470), and from the organizational structure data, both being transferred to rules formation unit (480), as shown in the drawing. Once the message's importance class is established by the classifier (450), it is then assigned to the message by the classifier (450).

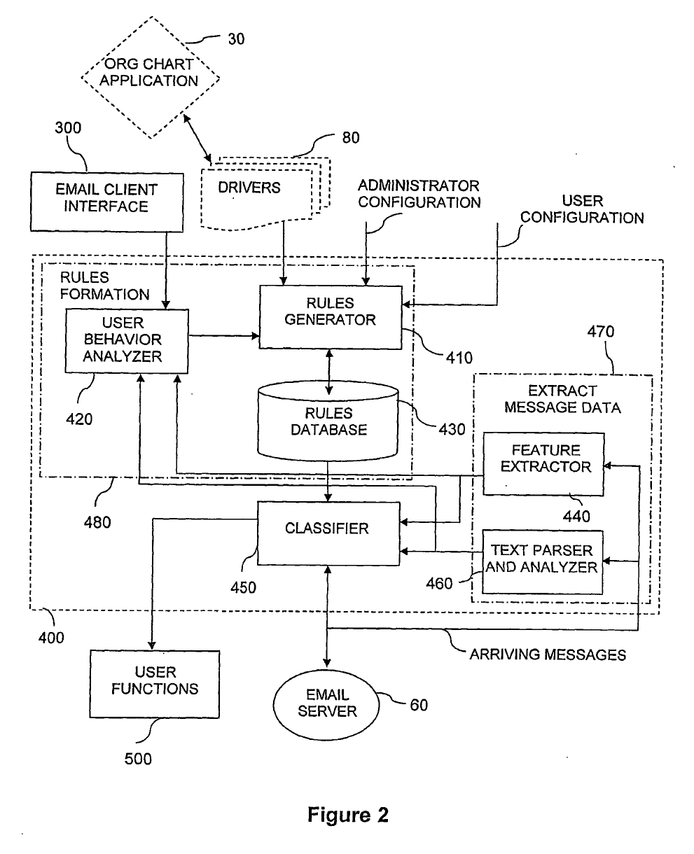

FIG. 2 describes in detail the classification engine (400) of FIG. 1. The classification engine (400) includes a rules generator (410) which receives organizational data from the org chart application (30), possibly through drivers (80) or other intermediating software, and configuration parameters from the system administrator and from the users. The user behavior agent (420) adaptively derives rules based on individual message handling.

The rules are stored in the rules database (430). The classifier (450) uses the rules from the database, along with the message features supplied by a feature extractor (440) and content items supplied by a text parser and analyzer (460), to determine the importance of each message. The rules generator (410), the user behavior agent (420) and the rules database (430) together constitute the rules formation unit (480) shown in FIG. 1. The feature extractor (440) together by the text parser and analyzer (460) constitute the extract message data unit (470) shown in FIG. 1.

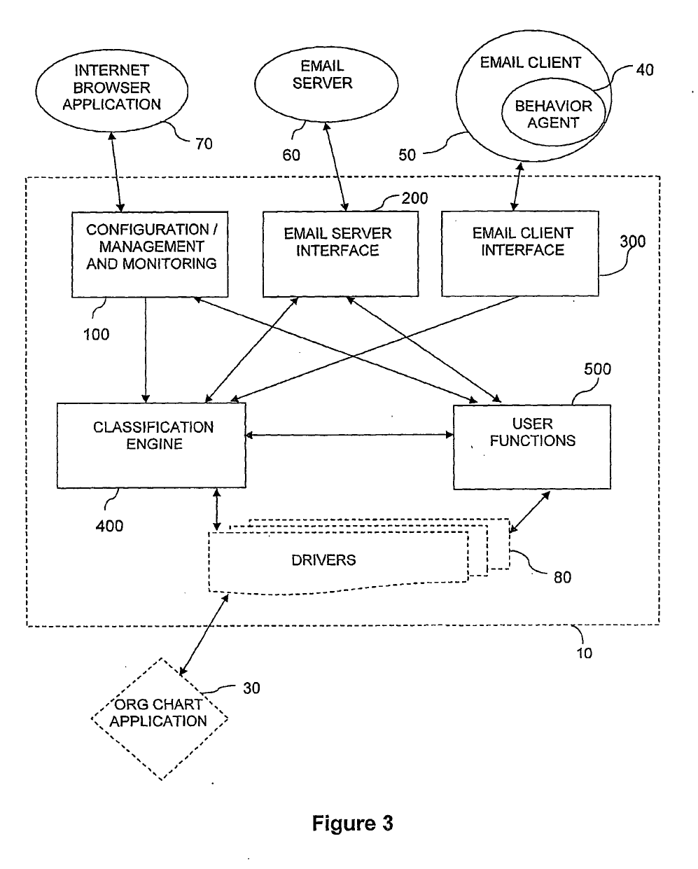

FIG. 3 illustrates the integration of a classification engine (400) as depicted in detail in FIGS. 1 and 2 in an overall environment (10), also referred to herewith as a “system”, adapted to the streamlining of electronic communication management. In the system (10) the classification engine (400) is coupled to a user functions module (500) which encapsulates the implementation of user related functions, such as the selective synchronization and the selective archiving functions. The classification engine (400) and the user functions module (500) are both coupled to an e-mail server interface (200) which serves for the transfer of e-mail messages as well as control and status messages between the e-mail server and the components in the environment (10) interacting with it. The user functions module (500) is also coupled with a configuration, management and monitoring module (100) which enables the system administrator to manage and configure the operation of the system (10) as well as to monitor its status and performance. The configuration, management and monitoring module (100) also allows for each individual user to modify the classification rules encapsulated in the classification engine (400), as well as selected modes of operation, for example, with the system (10) enabled or disabled, according to one's personal preferences. In further embodiments the configuration, management and monitoring module (100) comprises an interface for accessing configuration, management or monitoring functions over standard TCP/IP communication transport channels, such as HTTP (Hyper-Text Transfer Protocol), using a standard web browser application (70).

The Org Chart application (30) encapsulates the organization charts which is extracted from it through the drivers (80). In further embodiments the Org Chart application (30) includes tools for building a database describing the organizational structure, and for updating said database's records according to permanent or temporary changes in this structure.

It is to be appreciated that direct interaction between the client computer and the system components is reduced to a minimum necessary.

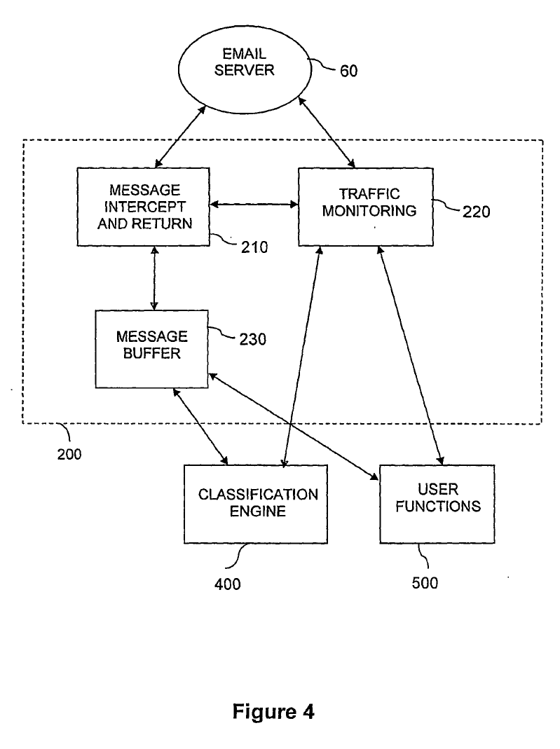

FIG. 4 depicts in detail the e-mail server interface (200) shown in FIG. 3. The functionality of the e-mail server interface (200) comprises monitoring message traffic inside the e-mail server, interception of incoming and outgoing messages, transferring those messages or copies thereof to ether modules featured in the environment (10) of FIG. 3, such as the classification engine (400) and the user functions (500), and sending the messages back to the e-mail server after or during their processing procedure by the different units of system (10).

The traffic monitoring unit (220) detects messages arriving to users' inboxes hosted on the e-mail server, and activates the Message Intercept and Return module (210), which posts them in the message buffer (230) for further processing by the classification engine (400). The message buffer (230) dequeues importance-tagged messages after being processed by the classification engine (400), and places them in the recipient's mailbox with the proper importance attribute.

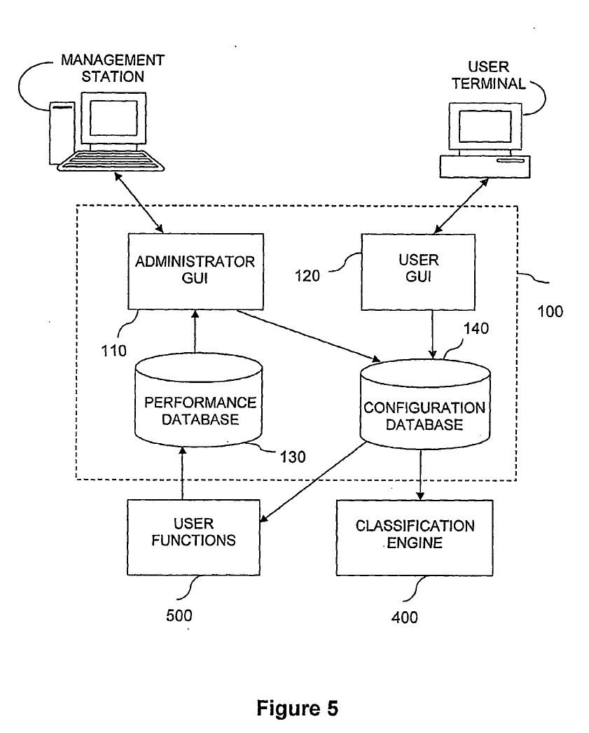

FIG. 5 illustrates in detail the configuration, management and monitoring module (100) depicted in FIG. 3. The configuration, management and monitoring module (100) allows for system administrators to configure a plurality of parameters of the system (10) in FIG. 3 for optimal performance, and to adapt said system for specific needs of a certain organization. In addition the module (100) enables the administrator to monitor the performance of the system (10) and to perform fault tracking. E-mail users can also utilize the module (100) for personal preferences setting. The module (100) includes a configuration database (140) for maintaining the administrator's and the users' settings, and a performance database (130), for maintaining the performance data, such as messages distribution, malfunctions and exceptions; usage monitoring and other reports, as well as a list of logging parameters. The module (100) further supplies graphical tools for said configuration, management and monitoring purposes, in the means of an administrator GUI (110) and a user GUI (120), as will be explained and illustrated in detail hereinafter.

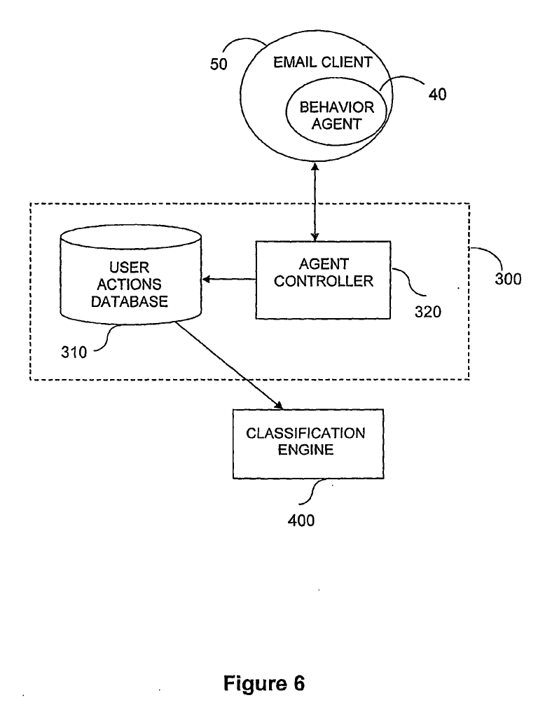

FIG. 6 describes in detail the e-mail client interface (300) depicted in FIG. 3. The e-mail client interface (300) includes an agent controller (320) that controls a behavior agent (40) sitting in the e-mail client (50) which captures the user actions on received messages. The behavior agent (40) can be remotely installable and executable. The agent controller (320) receives user action information in addition to a designator to the corresponding message, and stores them in the user's actions database (310) for use by the classification engine (400).

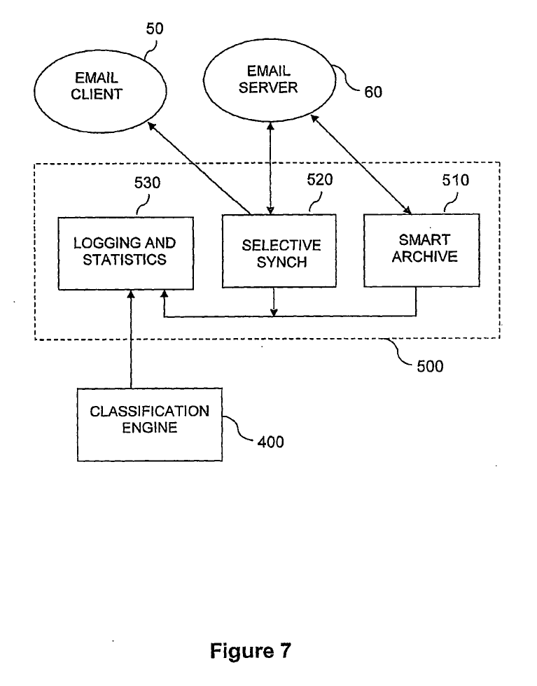

FIG. 7 describes in detail the user functions module (500) depicted in FIG. 3. The user functions module (500) includes a selective synchronization module (520) which allows e-mail clients to limit their inbox exclusively to e-mails with a predefined importance level, and a selective archiving module (510) which allows archiving messages residing in the user's inbox, whose importance class is beneath a predetermined threshold. The selective archiving module (510) also enables convenient easy search and retrieval of previously archived messages.

Specifically, the selective synchronization module (520) allows a selective transmission of e-mail messages from the e-mail server's inbox to the client computer's inbox, according to a predefined importance level.

The selective mailbox synchronization procedure in a system according to a preferred embodiment of the present invention is as follows:

(a) The traffic monitoring unit (220) in the e-mail server interface module (200) receives a “request for synch” event from the e-mail server

(b) The selective synchronization module (520) checks the importance tag of each message before its transfer to the client computer, and approves or prevents the transfer according to the corresponding importance tag.

Each e-mail user sets the following parameter that affects the functionality of the selective synchronization module (520):

Synchronization_importance (messages of this importance level and above is transferred to the client)

The selective archiving module (510) allows “smart archiving” of previously received messages, by means of packing groups of e-mails residing in a user's inbox into archives according to their importance class, and the time elapsed since they were received.

The Smart Archiving function for each user is activated based on the preferences selected by the user:

Enable/disable archiving

Max_number_of_mails in inbox (start archiving after number is exceeded)

Max_inbox_memory_size (start archiving after size is exceeded)

Archive_importance (archive messages at this importance level or lower)

Archive_age_resolution (archive messages older than this value)

Destination folder names

Archived Messages are stored in compressed format in order to save storage space.

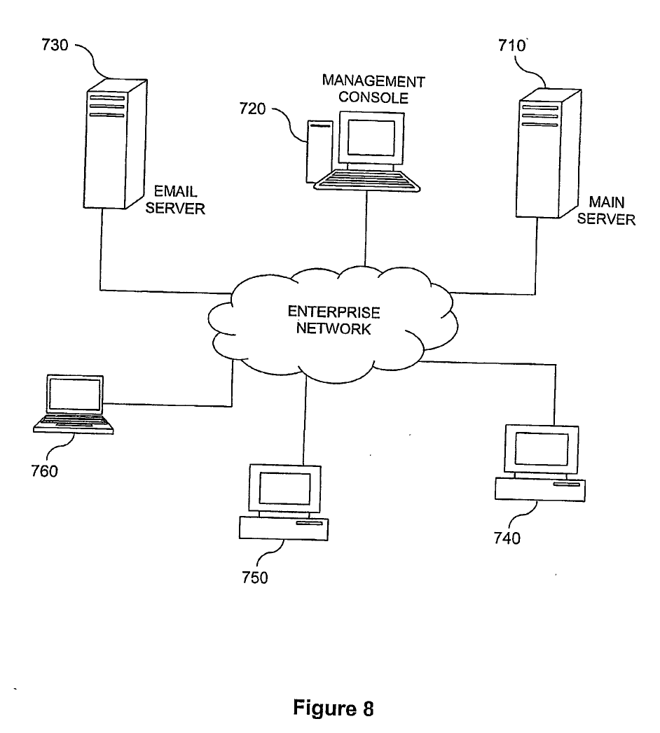

FIG. 8 illustrates the integration of the system (10) in an enterprise network according to one embodiment of the present invention. The enterprise network is a model of a working environment in which different computer programs and applications are running on a distant machine external to a user's computer and are accessed by the user through a web browser. The main server (710) runs the major components of the system (10), such as the classification-engine (400), the user functions module (500), and other related functions. The e-mail server (730), as well as the management console (720) and the users' computers (740)-(760) are all connected to the main server (710) through the enterprise network as shown in the drawing, thus enabling access to the configuration, management and monitoring module (100) of the system (10), using the graphical tools supplied by the module (100), such as the administrator GUI (110) on the management console (720), and the user GUI (120) on the users' computers (740)-(760).

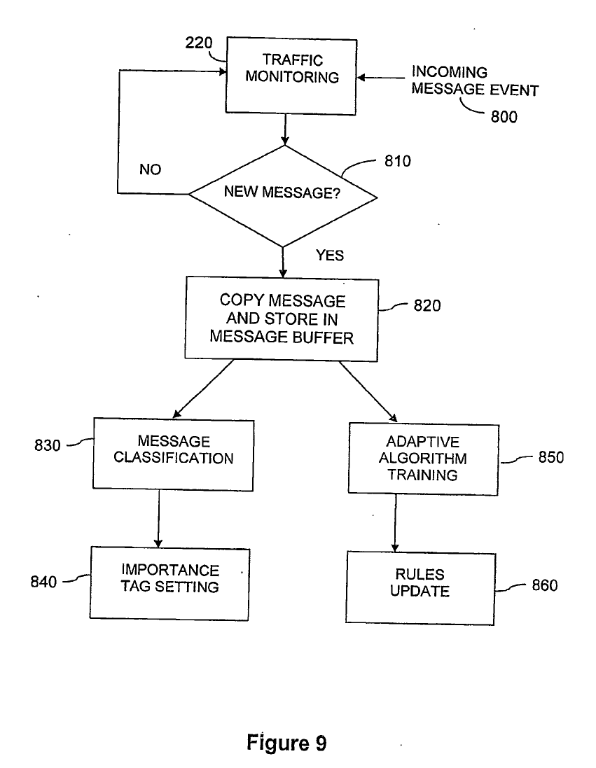

FIG. 9 depicts an example of the flow of execution from arrival of a message to a user's inbox until the notification thereof is presented to the user with the appropriate importance class indication. In step 800, the traffic monitoring unit (220) in the e-mail server interface (200) gets an event on a new message being stored in a users' inbox, i.e. an incoming message. In step 810, the traffic monitoring unit (220) determines whether the respective message related with said event is, indeed, new. If the message is new, in step 820 the message intercept and return unit (210) then copies the message and stores it in the message buffer (230), from which the classification engine (400) dequeues the message in step 830, sets its importance tag in step 840 and restores it in the message buffer (230). Finally, the message is returned to the mail server (overwriting a previous importance field, if any, or the entire message). In a preferred embodiment, the message is further used, in step 850, for adaptive algorithm training, as will be explained in detail hereinafter, eventually resulting, in step 860, in the update of classification rules maintained in the rules database (430) accordingly, as shown in the drawing.

It is to be appreciated that the method according to the present invention is being implemented on a copy of the message that is external to a central repository on which incoming messages are stored so as to enable uninterrupted service in the case that said method fails to operate or malfunctions, and furthermore to avoid loss of messages or messages parts.

In a preferred embodiment, the messages are stored by the e-mail server in the user's inbox concurrently with being processed by the system (10). After an importance class of a message has been determined the respective importance attribute of the message is updated accordingly.

A message stored in the message buffer (230) for classification is processed first by the feature extractor (440) and by the text parser and analyzer (460).

The text parser and analyzer (460) extracts content items from the message subject field and from the message body and passes them to the classifier (450) and to the user behavior analyzer (420). Content items are a list of key words, terms and phrases found in the text. The extraction of content items can be performed using known techniques such as in Schweighofer and Winiwarter, “Refining the selectivity of thesauri by means of statistical analysis”, in Intl. Congress on Terminology and Knowledge Engineering, 1993.

The feature extractor (440) extracts the following features from each message and passes them to the classifier (450) and to the user behavior analyzer. (420):

Sender's e-mail address and/or nickname

Recipient's e-mail address and/or nickname

Number of recipients in the “to” field

Number of recipients in the “cc” or “bcc” field

The classifier (450) applies rules from all categories in order to determine the message importance level. The rules are drawn from the rules database (430). The following categories of classification rules are applied, as will be explained in detail hereinafter:

(a) organizational

(b) content

(c) behavioral (adaptive)

The final importance level is a result of the weighted average of the outputs of all rule categories. The weighting factors are a function of predetermined values as well as the corresponding confidence level. The classifier contains a collection of reference “important” content items and reference “unimportant” content items, for comparison with content items found in the messages.

The importance class indication (the importance tag) is attached to each message. If the importance class is “unknown”, no tag is attached to that message.

The implementation of the importance tag enables a clear display of the importance class, by means of different colors or any other clearly visible tag, and allows “importance based” sorting in the e-mail client.

Four Importance classes are defined: high, medium, low, unknown Additional classes can be added upon need.

The final importance class is determined as a weighted average of the outputs of all rules categories. The output of each rule category is assigned a confidence level. If none of the conditions of a certain rule is fulfilled then the rule's output is: importance=unknown. The final importance class is calculated according to the following formula:

$$Final\_importance = INT ( \frac{\sum W ( i ) * IC ( i )}{\sum W ( i )} + 0.5 )$$

Where:

IC(i)—importance class determined by rule category i, where IC=1 for low importance, 2 for medium importance, 3 for high importance, 0 for unknown importance.

W(i)—weighting factor of rule category i, where 0≦W≦1.

The weighting factor for each rule category is calculated as follows:
W=W_{—}const*CF

Where:

W_const—the constant weighting factor for that category as configured by the administrator.

CF=confidence factor for that category (CF assumes values between zero and one, where a zero designates no confidence and a one designates full confidence).

All weighting coefficients, decision thresholds and other constants are configurable through the administrator GUI (110). A limited number of parameters are configurable through the user GUI (120).

The “organizational” rules category may include rules as in the following list:

If <organizational distance=low> then <importance=high>

If <organizational distance=medium> then <importance=medium>

If <organizational distance=high> then <importance=low>

If <sender & recipient belong to workgroup> then <importance=high>

If <address is external and address belongs to preferred list> then <importance=high>

The organizational distance is calculated as follows:
Org_{—}dis=dep_{—}dis+her_{—}dis

Where:

dep_dis is the departmental distance and her_dis is the hierarchal distance

Dep_dis can assume 3 values—0, 1, 2 (where 0 corresponds to the same department).

Her_dis can assume the values—0, 1, 2, 3, . . . (where 0 corresponds to the same hierarchal layer, 1 corresponds to +/−1 level difference etc.).

Organizational distance is defined as follows:

If (org_dis<=T1) then (organizational distance=low)

If (org_dis>T1 and <=T2) then (organizational distance=medium)

Else (organizational distance=high)

Default values: T1=1, T2=2

Each user may define a set of personal preferences relating to senders internal or external to the organization. Such user's personal settings can only increase the importance set by the administrator. For example, personal preferences may be of the following types,

(a) If <sender belongs to preferred_interal_address> then <importance=high>

(b) If <sender belongs to preferred_external_address> then <importance=high>

The system allows setting importance classes according to a global list of preferred originating addresses, external to the organization, from senders affiliated with the organization, such as customers, suppliers, partners, etc. The list of preferred external addresses is defined by the system administrator or is drawn from the data bases of exiting enterprise applications such as enterprise resource planning (ERP) or customer resource management (CRM).

The system allows the setting of importance classes according to the SMTP (Simple Mail Transfer Protocol) message headers such as “to”, “cc” and “bcc” fields. Following are some examples for such rules:

If <recipient alone in “to” header> then <importance=high>

Else If <# of recipients in “to” header less then N1> then <importance=medium>

If <recipient alone in “cc” header> then <importance=medium>

If <recipient alone in “bcc” header> then <importance=high>

Else <importanc=unknown>

The importance class set by the organizational category is according to the following rule:

If at least one rule voted “high” then IC=high

Else if at least one rule voted “medium” then IC=medium

Else if at least one rule voted “low” then IC=low

Else IC=unknown

The confidence level of the organizational rule category is calculated as follows:

If one rule voted for the selected importance class then CF=CF_mm

If two rules voted for the selected importance class then CF=CF_medium

If three or more rules voted for the selected importance class then CF=CF_max

Default values: CF_min=0.7, CF_medium=0.85, CF_max=1

The function of the content based rules is to assist in classifying e-mail messages on two levels:

(a) Higher rating of relevant, work-related content

(b) Lower rating of irrelevant content such as jokes, music files, video files, solicitation etc.

There are numerous prior art methods for classifying text messages according to their content (one such method is described in U.S. Pat. No. 6,519,580). One simple method is a simple “search and count” operation of given reference keyword. The present invention is not limited to any specific text classification method.

The following content rules are applied:

if <message_subject_content_item belongs to irrelevant_class> then <importance=low> (multiple irrelevant classes are supported) ELSE If <message_subject_content_item belongs to relevant_class> then <importance=high> (multiple irrelevant classes are supported).

If <message_body_content_item belongs to irrelevant_class> then <importance=low> (multiple irrelevant classes are supported). ELSE If <message_body_content_item belongs to relevant_class> then <importance=high> (multiple irrelevant classes are supported).

Most “reference content-classes” are defined by the system administrator. A limited number of “personal reference content classes” can be defined by each user, provided that they do not conflict with administrator defined classes. For example, if a user specifies a key word as “unimportant” and the same keyword was already defined by the administrator as “important”, the system rejects the personal setting.

Most prior art methods for classifying text messages also generate a confidence indication that can be used for calculation of the final importance class. For a simple key word “search and count” method the following simple algorithm can be used to estimate the confidence factor of the content rule category:

If # of matching key words is larger then N_min but smaller then N_medium then CF=CF_min

If # of matching key words is larger then N_medium but smaller then N_max then CF=CF_medium

If # of matching key words is larger then N_max then CF=CF_max

Default N values: N_min=2, N_medium=4, N_max=6

Default CF values: CF_min=0.7, CF_medium=0.85, CF_max=1

Adaptive rules are generated based on the user's actions taken on previously received e-mail messages. The behavioral information is recorded for all e-mail receiving users as defined by the system administrator. The behavioral information for each user is recorded on a statistically sufficient number of messages (several hundreds). The behavioral information is used to deduce the message importance. This information is used to produce rules that relate various message attributes to the importance level of messages. Those rules are used in the process of classifying new messages. The classification outcome of the % adaptive algorithm is accompanied by a corresponding confidence factor estimation that is used for the calculation of the final importance class as described above.

The following “user actions” taken on received e-mail messages are recorded by the “user behavior agent”, causing minimal interference with the client computer:

(a) Time elapsed from the moment the message was stored in the inbox till it was opened by the user

(b) Time elapsed from the moment user started e-email activity (after the message was stored in the inbox) till it was opened

(c) Time during which the message remained open

(d) Replying to the message

(e) Forwarding the message

(f) Filing or saving the message

(g) Deleting the message

(h) Printing the message

The following importance criteria are applied:

If <time_to_open=short then <importance=high>

If <time_to_open_since_activity_started=short> then <importance=high>

If <time_message_opened=long or time_attachment_open=long> then <importance=high>

If <message replied> then <importance=high>

If <message forwarded and filed/saved> then <importance=high>

If <message printed> then <importance=high>

If <message forwarded> then <importance=medium>

If <message filed/saved> then <importance=medium>

If <message deleted> then <importance=low>

The final importance class is determined as a weighted average of the above criteria, according to the following formula:

$$IC\_W = INT ( \frac{\sum W ( i ) * IC ( i )}{\sum W ( i )} + 0.5 )$$

The following attributes are extracted and rated.

(a) Message sender

(b) Organizational distance between sender and recipient

(c) “Subject” field content

(d) Message body content

(e) Recipient alone in “to” header field

(f) Recipient alone in “cc”or “bcc” header field

(g) Or a combination of two or more of the above

The adaptive, behavioral based, rules are generated using, for example, prior art techniques such as:

(a) Naïve Bayes

(b) Rule learning or machine learning Algorithms

(c) Support Vector Machine

Adaptively generated rules have a limited, configurable, validity time (training is performed over the last N days). The algorithm is applied continuously in order to adjust for dynamic conditions.

The system allows the administrator to define the organizational structure using a Graphical User Interface (GUI), or to import it from an existing enterprise database. After defining/importing the org chart, the administrator is able to subscribe employees to the invention's services. This is done by clicking the “subscribe users” button, and then selecting from the org chart the following options:

(a) The entire company

(b) Whole departments

(c) Whole hierarchal layers

(d) Individual users

For all subscribed employees, the system searches the corporate database and retrieve their personal details (e-mail address, nickname). For names not found, the system prompts the administrator to manually enter the corresponding data.

The system provides a graphical tool for convenient definition of the org_dis parameter. The tool is applied to the standard graphical view of the org chart.

Dep_dis between departments is defined by marking a distance between two departments by clicking them one after another. The GUI prompts the user to choose the distance value, for both directions (message sent from one department to the second and for the opposite direction). A definition of distance between two departments also applies to all their sub departments.

Specifying a distance between sub departments (sub department may consist also an individual in a department or a group of individuals in a department) overrides the distance defined between the parent departments.

A distance is marked between two individuals by selecting the two. An individual distance definition overrides the distance defined between the departments and/or the sub departments (for said individuals only).

The system allows the selection of a group of individuals that belong to a workgroup (with or without a time limit). For all individuals who belong to the workgroup−org_dis=low. The system alerts the administrator T before expiration of the workgroup validity period (T=1 week). For workgroup definition the system treats department managers as individuals and not as representatives of their departments.

The add/remove users screen allows the administrator to add or remove employees' subscription to the invention's services after the initial system installation. After selecting the add/remove button the administrator is presented with the org chat screen, where he is able to add/remove/change the user in the org chart, and then subscribe/unsubscribe him in the procedure described above.

Data on the performance of the invention is logged in the database for history recording, offline performance analysis, performance improvements and user behavior profiling. The system allows for easy application of various statistical analysis operators (average, standard deviation, histograms, correlation etc.) and graphical presentation of the results. A partial list of parameters for logging may include:

(a) Distribution of messages according to their importance level (per corporate, department or individual user).

(b) Correlation between rules categories and specific rules results, and the final importance setting.

(c) Correlation between user behavior and the final importance setting (per corporate, department or individual user).

(d) Monitoring of changes made by users to their personal preferences.

(e) The behavior of the above data over time (daily, weekly, monthly and yearly-resolution).

It will also be understood that the system according to the invention may be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

In the method claims that follow, alphabetic characters and Roman numerals used to designate claim steps are provided for convenience only and do not imply any particular order of performing the steps.

1. A method of assigning importance classes to electronic messages, the method comprising:
(a) identifying a sender of an electronic message;
(b) identifying a recipient of the electronic message;
(c) determining a relative organizational distance between the sender and the recipient; and
(d) assigning the electronic message an importance class as a function of the relative organizational distance between the sender and the recipient;
characterized in that:
(e) said function assigns the importance class in inverse dependence on the relative organizational distance between the sender and the recipient.

2. The method according to claim 1, wherein said function is further weighted by at least one additional criterion, selected from the following:
(a) a globally defined content criterion;
(b) a personally defined message sender criterion;
(c) a personally defined content criterion;
(d) a plurality of rules formed by a machine-learning algorithm or algorithms.
(e) an analysis of e-mail message headers.

3. The method according to claim 2, wherein the at least one additional criterion is a function of content in the message subject field and/or in the message body.

4. The method according to claim 2, wherein assigning the electronic message an importance class includes analyzing actions taken by said recipient on receipt of said messages so as to establish a relative importance ascribed by the recipient to received messages.

5. The method according to claim 1, wherein said electronic message is an electronic mail (e-mail) message.

6. The method according to claim 1, wherein said electronic message is a facsimile message.

7. The method according to claim 1, wherein said electronic message is a converted voice message or pager message text data.

8. The method according to claim 1, wherein the relative organizational distance between the sender and the recipient is determined from an organizational structure of a corporation and said function is refined according to one or more of the following:
(a) a set of global control rules according to the organizational structure and the work affiliation among different departments and different hierarchical layers in the corporation establishing organizational distance as a function of distance between respective hierarchical layers of the sender and recipient and of distance between departments in a common hierarchical layer;
(b) a set of control rules according to ad hoc work groups formed from time to time;
(c) a global list of preferred originating addresses, external to the organization, from senders affiliated with the organization.

9. A method for streamlining the management of electronic messages, the method comprising:
(a) assigning an importance class to each of said messages in inverse dependence on a relative organizational distance between a sender and recipient of the message; and
(b) streamlining said messages in a pre-determined manner in accordance with the respective importance class of each message.

10. The method for streamlining the management of electronic messages according to claim 9, wherein streamlining the messages includes displaying notifications of incoming messages in a color that is characteristic of the respective importance class of each message.

11. The method for streamlining the management of electronic messages according to claim 9, wherein streamlining the messages includes displaying in association with notifications of incoming messages a distinctive tag that is characteristic of the respective importance class of each message.

12. The method for streamlining the management of electronic messages according to claim 9, wherein streamlining the messages includes sorting notifications of incoming messages in a pre-determined order, indicating the relative importance of said messages in respect with their assigned importance classes.

13. The method for streamlining the management of electronic messages according to claim 9, wherein streamlining the messages includes blocking messages whose importance class is beneath a predetermined threshold.

14. The method according to claim 13, further including alerting the sender that a message has been blocked.

15. The method according to claim 9 being implemented on a copy of the message that is external to a central repository on which incoming messages are stored so as to enable uninterrupted service in the case that said method fails to operate or malfunctions.

16. The method according to claim 9 including selectively transmitting e-mail messages from an e-mail server's inbox to a client computer's inbox, according to said importance class.

17. The method according to claim 9, further including grouping messages residing in a user's inbox into archives, according to their importance class and an elapsed time since they were received.

18. The method according to claim 1, including using a graphical tool to define the organizational distance between different entities within the organization.

19. A system for assigning importance classes to electronic messages, said system comprising:
a message data extraction unit for identifying a sender and a recipient of an electronic message; and
a classifier coupled to the message data extraction unit and being responsive to a relative organizational distance between the sender and the recipient for assigning an importance class to the electronic message in inverse dependence on the relative organizational distance between the sender and the recipient.

20. The system according to claim 19, wherein the classifier is further adapted to assigning said importance class based on at least one additional criterion, selected from the following:
(a) a pre-defined message sender criterion;
(b) a pre-defined content criterion;
(c) a plurality of rules formed by a machine-learning algorithm tracing user actions;
(d) an analysis of e-mail message headers.

21. The system according to claim 19, further including a rules formation unit comprising:
(a) a set of global control rules relating to an organizational structure and work affiliation among different departments and different hierarchical layers thereof;
(b) a set of control rules relating to ad hoc work groups formed from time to time in said organizational structure; and
(c) a global list of preferred originating addresses external to the organizational structure.

22. (canceled)

23. (canceled)

24. A program storage device readable by machine, tangibly embodying a program of instructions executable by the machine to perform a method for assigning importance classes to electronic messages, the method comprising:
(a) identifying the sender of an electronic message;
(b) identifying the recipient of the electronic message;
(c) determining a relative organizational distance between the sender and the recipient; and
(d) assigning the electronic message an importance class as a function of the relative organizational distance between the sender and the recipient in inverse dependence on the relative organizational distance between the sender and the recipient.

25. A computer program product comprising a computer useable medium having computer readable program code embodied therein of assigning importance classes to electronic messages, the computer program product comprising:
computer readable program code for causing the computer to identify a sender of an electronic message;
computer readable program code for causing the computer to identify a recipient of the electronic message;
computer readable program code for causing the computer to determine a relative organizational distance between the sender and the recipient; and
computer readable program code for causing the computer to assign the electronic message an importance class as a function of the relative organizational distance between the sender and the recipient in inverse dependence on the relative organizational distance between the sender and the recipient.
